(19) United States
(12) Patent Application Publication
(10) Pub. No.: US 2026/0240226 A1
(43) Pub. Date: Aug. 20, 2026

(54) AEROSOL-GENERATING ARTICLE HAVING COMPRESSIBLE UPSTREAM ELEMENT

(71) Applicant: Philip Morris Products S.A., Neuchatel (CH)

(72) Inventors: Bruno Christian Joseph CHASSOT, Auvernier (CH); Marie FARINE, Sugiez (CH); Jerome UTHURRY, Neuchatel (CH)

(73) Assignee: Philip Morris Products S.A., Neuchatel (CH)

(21) Appl. No.: 19/131,034

(22) PCT Filed: Dec. 18, 2023
(86) PCT No.: PCT/EP2023/086427

§ 371 Date: May 19, 2025

(30) Foreign Application Priority Data
Dec. 22, 2022 (EP) 22216189

(51) Int. Cl. A24D 1/20; A24B 13/02; A24B 15/16; A24D 1/00; A24D 3/04; A24D 3/06; A24D 3/10; A24D 3/17; A24F 40/20; A24F 40/465; H05B 3/22

(52) U.S. Cl. CPC A24D 1/20; A24B 13/02; A24B 15/16; A24D 1/002; A24D 3/048; A24D 3/063; A24D 3/10; A24D 3/17; A24F 40/20; A24F 40/465; H05B 3/22

(57) ABSTRACT

An aerosol-generating article for producing an inhalable aerosol upon heating is provided, the aerosol-generating article extending from a mouth end to a distal end and including: a rod of aerosol-generating substrate having a density of less than 300 mg per cubic centimetre; a downstream section located downstream of the rod of aerosol-generating substrate, the downstream section extending from a downstream end of the rod of aerosol-generating substrate to the mouth end of the aerosol-generating article; and a compressible upstream element located upstream of the rod of aerosol-generating substrate, the compressible upstream element being formed from a filter material and having a density of less than 140 mg per cubic centimetre.

The present invention relates to an aerosol-generating article comprising an upstream element and to a system comprising such an aerosol-generating article.

Aerosol-generating articles in which an aerosol-generating substrate, such as a tobacco-containing substrate, is heated rather than combusted, are known in the art. Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate. As an alternative, inductively heatable aerosol-generating articles comprising an aerosol-generating substrate and a susceptor arranged within the aerosol-generating substrate have been proposed by WO 2015/176898. A further alternative has been described in WO 2020/115151, which discloses an aerosol-generating article used in combination with an external heating system comprising one or more heating elements arranged around the periphery of the aerosol-generating article.

Typically, aerosol-generating articles have been produced with a substantially round cross-section such that the aerosol-generating substrate is cylindrical. The device cavity of the corresponding aerosol-generating device for heating the aerosol-generating article will often have a cylindrical shape and size which is configured to substantially match that of the aerosol-generating substrate, such that the aerosol-generating substrate can be easily received and retained within the device cavity during heating.

However, it has been proposed to provide a modified aerosol-generating device having a device cavity with a rectangular cross-section, which comprises opposed planar walls, at least one of which is provided with a heater element on its surface. Such an arrangement provides a potentially greater surface area over which the aerosol-generating substrate can be heated and significantly improves the efficiency of heating of the aerosol-generating substrate. It also provides a more compact aerosol-generating system, which is easier to manufacture. However, it may be difficult for the consumer to use such an aerosol-generating device with the conventional, cylindrical aerosol-generating articles, as it may be difficult to compress or deform the cylindrical aerosol-generating substrate sufficiently to insert it into the rectangular device cavity. This will be particularly the case when the planar walls of the device cavity are relatively close together, such that the distance between the planar walls is significantly smaller than the diameter.

Accordingly, there is a need for an aerosol-generating article which is adapted such that it is more compatible with an aerosol-generating device having a rectangular device cavity.

According to the present disclosure there is provided an aerosol-generating article for producing an inhalable aerosol upon heating, the aerosol-generating article extending from a mouth end to a distal end and. The aerosol-generating article may comprise a rod of aerosol-generating substrate. The rod of aerosol-generating substrate may have a density of less than 300 mg per cubic centimetre. The aerosol-generating article may further comprise a downstream section located downstream of the rod of aerosol-generating substrate, the downstream section extending from a downstream end of the rod of aerosol-generating substrate to the mouth end of the aerosol-generating article. The aerosol-generating article may further comprise a compressible upstream element located upstream of the rod of aerosol-generating substrate. The upstream element may have a density of less than 140 mg per cubic centimetre.

According to the present invention there is provided an aerosol-generating article for producing an inhalable aerosol upon heating, the aerosol-generating article extending from a mouth end to a distal end and comprising: a rod of aerosol-generating substrate having a density of less than 300 mg per cubic centimetre; a downstream section located downstream of the rod of aerosol-generating substrate, the downstream section extending from a downstream end of the rod of aerosol-generating substrate to the mouth end of the aerosol-generating article; and a compressible upstream element located upstream of the rod of aerosol-generating substrate, wherein the upstream element has a density of less than 140 mg per cubic centimetre.

The term “aerosol-generating article” is used herein to denote an article comprising an aerosol-generating substrate which is heated to produce and deliver an inhalable aerosol to a consumer. As used herein, the term “aerosol-generating substrate” denotes a substrate capable of releasing volatile compounds upon heating to generate an aerosol.

As used herein, the term “aerosol-generating device” refers to a device comprising a heater element that interacts with the aerosol-generating substrate of the aerosol-generating article to generate an aerosol.

As used herein with reference to the present invention, the term “rod” is used to denote a generally elongate element, preferably a cylindrical element of substantially circular, oval or elliptical cross-section.

As used herein, the term “longitudinal” refers to the direction corresponding to the main longitudinal axis of the aerosol-generating article, which extends between the upstream and downstream ends of the aerosol-generating article. As used herein, the terms “upstream” and “downstream” describe the relative positions of elements, or portions of elements, of the aerosol-generating article in relation to the direction in which the aerosol is transported through the aerosol-generating article during use.

During use, air is drawn through the aerosol-generating article in the longitudinal direction. The term “transverse” refers to the direction that is perpendicular to the longitudinal axis. Any reference to the “cross-section” of the aerosol-generating article or a component of the aerosol-generating article refers to the transverse cross-section unless stated otherwise.

The term “length” denotes the dimension of a component of the aerosol-generating article in the longitudinal direction. For example, it may be used to denote the dimension of the rod or of the downstream section in the longitudinal direction.

The term “density” as used herein in relation to the aerosol-generating substrate and upstream element refers to the bulk density of the aerosol-generating substrate or upstream element, respectively. For the rod of aerosol-generating substrate, this can be calculated by measuring the total weight of the aerosol-generating substrate and dividing this by the volume of the segment of aerosol-generating substrate (excluding any wrapper). The initial density of the aerosol-generating substrate refers to the density of the aerosol-generating substrate prior to insertion into the aerosol-generating device. The final density of the aerosol-generating substrate refers to the density of the aerosol-generating substrate once it is in place within the aerosol-generating device. For the upstream element, the bulk density can be calculated by measuring the total weight of the upstream element and dividing this by the volume of the upstream element (excluding any wrapper).

The present invention therefore provides an aerosol-generating article having a novel configuration which includes a combination of a rod of aerosol-generating substrate having a relatively low density of less than 300 mg per cubic centimetre and an upstream element which also has a relatively low density of less than 140 mg per cubic centimetre. This combination of features provides an upstream element and rod of aerosol-generating substrate which are more compressible than for a typical aerosol-generating article. This advantageously facilitates the compression and deformation of the aerosol-generating substrate which are needed in order to insert the aerosol-generating article into an aerosol-generating device having a heating chamber with a cross-section that is different to the cross-section of the rod of aerosol-generating substrate and in particular, a cross-section that is rectangular, as described above.

The relatively low density of the rod of aerosol-generating substrate enables the aerosol-generating substrate be more easily compressed and the initial density of the rod of aerosol-generating substrate, prior to insertion of the aerosol-generating article into an aerosol-generating device, is selected such that the final density of the rod of aerosol-generating substrate, after its compression upon insertion into an aerosol-generating device will provide a suitable level of resistance to draw (RTD).

In a similar way, the relatively low density of the upstream element also enables the upstream element to be more easily compressed than a conventional upstream element. The compression of the upstream element to a similar degree as the rod of aerosol-generating substrate is likely to be essential in order to insert the aerosol-generating article into an aerosol-generating device having a rectangular heating chamber, as described above. The inclusion of the upstream element should therefore facilitate the insertion of the aerosol-generating article into the heating chamber of an aerosol-generating device rather than obstructing it. The inclusion of the upstream element may additionally protect the end of the rod of aerosol-generating substrate during the insertion of the article into the cavity such that the risk of damage to the substrate is minimised. This may be particularly important in view of the increased manipulation of the rod of aerosol-generating substrate that is likely to be necessary in order to insert it into the heating chamber.

The upstream element additionally provides further technical benefits. The upstream element advantageously prevents direct physical contact with the upstream end of the aerosol-generating substrate. For example, where the aerosol-generating substrate comprises a susceptor element, the upstream element may prevent direct physical contact with the upstream end of the susceptor element. This helps to prevent the displacement or deformation of the susceptor element during handling or transport of the aerosol-generating article. This in turn helps to secure the form and position of the susceptor element.

Furthermore, the presence of an upstream element helps to prevent any loss of the substrate, which may be particularly advantageous in the present invention, where the initial density of the aerosol-generating substrate is relatively low. Where the aerosol-generating substrate comprises shredded tobacco, such as tobacco cut filler, the upstream section or element thereof may additionally help to prevent the loss of loose particles of tobacco from the upstream end of the article.

The upstream element may also additionally provide a degree of protection to the aerosol-generating substrate during storage, as it covers at least to some extent the upstream end of the aerosol-generating substrate, which may otherwise be exposed.

The upstream element may also provide an improved appearance to the upstream end of the aerosol-generating article. Furthermore, if desired, the upstream element may be used to provide information on the aerosol-generating article, such as information on brand, flavour, content, or details of the aerosol-generating device that the article is intended to be used with.

The upstream element may have a density of less than 200 grams per cubic centimetre, or less than 175 grams per cubic centimetre, or less than 150 grams per cubic centimetre. According to the invention, the upstream element has a density of less than 140 grams per cubic centimetre. Preferably, the density of the upstream element is less than 138 grams per cubic centimetre, more preferably less than 136 grams per cubic centimetre, more preferably less than 134 grams per cubic centimetre, more preferably less than 132 grams per cubic centimetre, more preferably less than 130 grams per cubic centimetre.

The upstream element preferably has a density of at least 85 mg per cubic centimetre, more preferably at least 90 mg per cubic centimetre, more preferably at least 95 mg per cubic centimetre, more preferably at least 100 mg per cubic centimetre, more preferably at least 105 mg per cubic centimetre, more preferably at least 110 mg per cubic centimetre, more preferably at least 120 mg per cubic centimetre.

For example, the upstream element may have a density of between 85 mg per cubic centimetre and 140 grams per cubic centimetre, or between 90 mg per cubic centimetre and 138 grams per cubic centimetre, or between 95 mg per cubic centimetre and 136 grams per cubic centimetre, or between 100 mg per cubic centimetre and 134 grams per cubic centimetre, or between 105 mg per cubic centimetre and 132 grams per cubic centimetre, or between 110 mg per cubic centimetre and 130 grams per cubic centimetre, or between 120 mg per cubic centimetre and 130 mg per cubic centimetre.

The reduction in the density of the upstream element compared to the typical density of such elements increases the compressibility of the upstream element.

The upstream element is adapted to be compressible to a final density upon insertion of the upstream element and the rod of aerosol-generating substrate into the heating chamber of an aerosol-generating device. The upstream element is preferably adapted to be compressible to a final density that is at least 1.1 times the initial density, more preferably at least 1.25 times the initial density, more preferably at least 1.5 times the initial density, more preferably at least 1.75 times the initial density, more preferably twice the initial density. The upstream element may be compressible to a final density that is up to 4 times the initial density.

For example, the upstream element may be adapted to be compressible to a final density that is between 1.1 times and 4 times the initial density, or between 1.25 times and 4 times the initial density, or between 1.5 times and 4 times the initial density, or between 1.75 and 4 times the initial density, or between 2 times and 4 times the initial density, or between 1.1 times and 3 times the initial density, or between 1.25 times and 3 times the initial density, or between 1.5 times and 3 times the initial density, or between 1.75 and 3 times the initial density, or between 2 times and 3 times the initial density.

Preferably, the upstream element is adapted to be compressible to a final density of at least 100 mg per cubic centimetre, more preferably at least 110 mg per cubic centimetre, more preferably at least 120 mg per cubic centimetre, more preferably at least 125 mg per cubic centimetre, more preferably at least 130 mg per cubic centimetre, more preferably at least 135 mg per cubic centimetre, more preferably at least 140 mg per cubic centimetre.

Preferably, the upstream element is adapted to be compressible to a final density of less than 350 mg per cubic centimetre, more preferably less than 300 mg per cubic centimetre, more preferably less than 275 mg per cubic centimetre, more preferably less than 250 mg per cubic centimetre, more preferably less than 225 mg per cubic centimetre, more preferably less than 200 mg per cubic centimetre, more preferably less than 175 mg per cubic centimetre.

For example, the upstream element is adapted to be compressible to a final density of between 100 mg per cubic centimetre and 350 mg per cubic centimetre, or between 110 mg per cubic centimetre and 300 mg per cubic centimetre, between 120 mg per cubic centimetre and 275 mg per cubic centimetre, or between 125 mg per cubic centimetre and 250 mg per cubic centimetre, or between 130 mg per cubic centimetre and 225 mg per cubic centimetre, or between 135 mg per cubic centimetre and 200 mg per cubic centimetre, or between 140 mg per cubic centimetre and 175 mg per cubic centimetre.

The upstream element may be made of any material suitable for use in an aerosol-generating article and which provides the desired degree of compressibility. Suitable materials for forming the upstream element include filter materials, ceramic, polymer material, cellulose acetate, cardboard, zeolite or aerosol-generating substrate.

In preferred embodiments, the upstream element is formed of a fibrous filtration material. Particularly preferably, the upstream element is formed of a segment of cellulose acetate tow.

Preferably, the upstream element is formed of a fibrous filtration material having a denier per filament (dpf) of less than 12, or less than 8 or less than 4. More preferably, the denier per filament (dpf) is less than 3. The denier per filament (dpf) of the fibrous filtration material is preferably less than 2.9, more preferably less than 2.8, more preferably less than 2.7, more preferably less than 2.6.

Preferably, the denier per filament (dpf) of the fibrous filtration material is at least 2, more preferably at least 2.1, more preferably at least 2.2, more preferably at least 2.3, more preferably at least 2.4.

For example the denier per filament (dpf) may be between 2 and 12, or between 2 and 8, or between 2 and 4, or between 2 and 3, or between 2.1 and 2.9, or between 2.2 and 2.8, or between 2.3 and 2.7, or between 2.4 and 2.6. The denier per filament may be around 2.5.

The denier per filament, corresponding to the average denier of an individual fibre within the upstream element, is the weight in grams of a single fibre or filament having a length of 9000 metres. In the present invention, the value of dpf therefore gives an indication of the thickness of each of the individual fibres within the upstream element. The denier per filament is expressed in units of denier, where 1 denier corresponds to 1 gram per 9000 metres. The dpf of a filter or filter segment can be readily determined based on the measurement of weight and length of a sample of representative fibres from the filter or filter segment.

The denier per filament of the fibrous filtration material forming the upstream element is therefore relatively low, which further improves the compressibility of the upstream element.

Preferably, the upstream element is formed of a fibrous filtration material having a total denier of less than 30,000, more preferably less than 25,000. The total denier may be around 20,000.

The “total denier” of the filtration material defines the total weight in grams of 9000 metres of the combined fibres forming the filtration material. The total denier for the filter segment therefore corresponds to the denier per filament multiplied by the total number of fibres in the filter segment.

Where the upstream element is formed of a fibrous filtration material, the fibrous filtration material preferably comprises a filter plasticiser. Preferably, the amount of filter plasticiser in the upstream element is less than 4 percent by weight based on total weight of the upstream element (excluding wrappers), more preferably less than 3.9 percent by weight, more preferably less than 3.8 percent by weight, more preferably less than 3.7 percent by weight, more preferably less than 3.6 percent by weight, based on total weight of the upstream element. Preferably, the amount of filter plasticiser in the upstream element is at least 3 percent by weight, more preferably at least 3.1 percent by weight, more preferably at least 3.2 percent by weight, more preferably at least 3.3 percent by weight, more preferably at least 3.4 percent by weight, based on total weight of the upstream element.

For example, the upstream element may have a filter plasticiser content of between 3 percent by weight and 4 percent by weight, or between 3.1 percent by weight and 3.9 percent by weight, or between 3.2 percent by weight and 3.8 percent by weight, or between 3.3 percent by weight and 3.7 percent by weight, or between 3.4 percent by weight and 3.6 percent by weight, based on total weight of the upstream element. The upstream element may have a filter plasticiser content of about 3.5 percent by weight, based on the total weight of the upstream element.

The amount of filter plasticiser in the fibrous filtration material is therefore relatively low, which further improves the compressibility of the upstream element. The relatively low level of filter plasticiser may also ensure that the compression of the upstream element does not result in an unacceptable increase in the resistance to draw (RTD) of the upstream element. In general, retaining a relatively low level of filter plasticiser will advantageously allow better control of the RTD upon compression of the upstream element. Providing a higher level of filter plasticiser may make the upstream element harder to compress but may also cause unwanted channels to be set up at the outside of the upstream element upon compression, which would lead to an unacceptable decrease in overall RTD.

Suitable filter plasticisers for use in the upstream element of the aerosol-generating article of the present invention would be known to the skilled person. Preferably, the filter plasticiser is triacetin. Preferably, the upstream element comprises cellulose acetate tow with triacetin as filter plasticiser.

The upstream element may alternatively be formed of a cardboard or paper material.

In certain preferred embodiments, the upstream element is formed of a solid cylindrical plug element having a filled cross-section. Such a plug element may be referred to as a ‘plain’ element. The solid plug element may be porous but does not have a tubular form and therefore does not provide any longitudinal flow channel. The solid plug element preferably has a substantially uniform transverse cross section.

In such embodiments, the upstream element preferably has a resistance to draw (RTD) of less than 25 millimetres H₂O, or less than 22 millimetres H₂O, or less than 20 millimetres H₂O. Preferably, in such embodiments, the upstream element has an RTD of at least 10 millimetres H₂O, or at least 12 millimetres H₂O, or at least 14 millimetres H₂O, or at least 16 millimetres H₂O. For example, the upstream element may have an RTD of between 10 millimetres H₂O and 25 millimetres H₂O, or between 12 millimetres H₂O and 22 millimetres H₂O, or between 14 millimetres H₂O and 20 millimetres H₂O, or between 16 millimetres H₂O and 20 millimetres H2O.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 are normally carried out at under test at a volumetric flow rate of 17.5 millilitres per second at the output or downstream end of the measured component at a temperature of 22 degrees Celsius, a pressure of 101 kPa (about 760 Torr) and a relative humidity of 60%. Conditions for smoking and smoking machine specifications are set out in ISO Standard 3308 (ISO 3308:2000). Atmosphere for conditioning and testing are set out in ISO Standard 3402 (ISO 3402:1999).

In other embodiments, the upstream element is formed of a hollow tubular segment defining a longitudinal cavity providing an unrestricted flow channel. In such embodiments, the upstream element can provide protection for the aerosol-generating substrate, as described above, whilst having a minimal effect on the overall resistance to draw (RTD) and filtration properties of the article.

Preferably, the diameter of the longitudinal cavity of the hollow tubular segment forming an upstream element is at least about 4 millimetres, more preferably at least about 4.5 millimetres, more preferably at least about 5 millimetres and more preferably at least about 5.5 millimetres. Preferably, the diameter of the longitudinal cavity is maximised in order to minimise the RTD of the upstream section, or upstream element thereof. An internal diameter of the upstream element may be about 5.1 mm.

Preferably, the wall thickness of the hollow tubular segment is less than about 2 millimetres, more preferably less than about 1.5 millimetres and more preferably less than about 1.25 millimetres. The wall thickness of the hollow tubular segment defining an upstream element may about 1 mm.

In such embodiments, the upstream element preferably has an RTD of less than 10 millimetres H₂O, more preferably less than 5 millimetres H₂O, more preferably less than 2.5 millimetres H₂O. Preferably, in such embodiments, the upstream element has an RTD of at least at least 0.1 millimetres H₂O, or at least about 0.25 millimetres H₂O or at least about 0.5 millimetres H₂O. For example, the upstream element may have an RTD of between 0.1 millimetres H₂O and 10 millimetres H₂O, or between 0.25 millimetres H₂O and 5 millimetres H₂O, or between 0.5 millimetres H₂O and 2.5 millimetres H₂O.

Preferably, prior to insertion of the aerosol-generating article into an aerosol-generating device, the upstream element has an external diameter that is approximately equal to the external diameter of the aerosol-generating article. Preferably, the external diameter of the upstream element prior to any compression is between 6 millimetres and 8 millimetres, more preferably between 7 millimetres and 7.5 millimetres. Preferably, the upstream element has an external diameter that is about 7.1 mm.

Preferably, the upstream element has a length of between 2 millimetres and 8 millimetres, more preferably between 3 millimetres and 7 millimetres, more preferably between 4 millimetres and 6 millimetres. In a particularly preferred embodiment, the upstream element has a length of about 5 millimetres. The length of the upstream section or an upstream element can advantageously be varied in order to provide the desired total length of the aerosol-generating article. For example, where it is desired to reduce the length of one of the other components of the aerosol-generating article, the length of the upstream section or an upstream element may be increased in order to maintain the same overall length of the article.

In addition, the length of the upstream element can be used to control the position of the aerosol-generating article within the heating chamber of an aerosol-generating device, for articles which are intended to be externally heated. This can advantageously ensure that the position of the aerosol-generating substrate within the heating chamber can be optimised for heating and the position of any ventilation can also be optimised.

The upstream element is preferably circumscribed by a wrapper, such as a plug wrap. The wrapper circumscribing the upstream element is preferably adapted such that it permits the necessary compression of the upstream element when the aerosol-generating article is inserted into an aerosol-generating device.

Preferably, the upstream element is circumscribed by a wrapper having a thickness of less than 50 microns, more preferably less than 45 microns, more preferably less than 40 microns, more preferably less than 35 microns, more preferably less than 30 microns.

Preferably, the upstream element is circumscribed by a wrapper having a basis weight of less than 35 grams per square metre, more preferably less than 30 grams per square metre, more preferably less than 25 grams per square metre, more preferably less than 20 grams per square metre.

The wrapper circumscribing the upstream element therefore preferably has a relatively low thickness and basis weight, so that the wrapper enables the required level of compression of the upstream element.

The upstream element is preferably connected to the rod of aerosol-generating substrate and optionally at least a part of the downstream section by means of an outer wrapper, as described herein. Preferably, the outer wrapper also has a relatively low thickness and basis weight, to enable the required level of compression of the upstream element and aerosol-generating substrate.

Preferably, the outer wrapper has a thickness of less than 75 microns, more preferably less than 70 microns, more preferably less than 65 microns, more preferably less than 60 microns, more preferably less than 55 microns.

Preferably, the upstream element is circumscribed by a wrapper having a basis weight of less than 50 grams per square metre, more preferably less than 45 grams per square metre, more preferably less than 40 grams per square metre, more preferably less than 35 grams per square metre.

As defined above, a rod of aerosol-generating substrate is provided downstream of the upstream element. Preferably, the upstream end of the rod of aerosol-generating substrate abuts the downstream end of the upstream element.

According to the invention, the rod of aerosol-generating substrate has a density of less than 300 mg per cubic centimetre more preferably less than 275 mg per cubic centimetre, more preferably less than 250 mg per cubic centimetre, more preferably less than 225 mg per cubic centimetre, more preferably less than 200 mg per cubic centimetre, more preferably less than 175 mg per cubic centimetre, more preferably less than 150 mg per cubic centimetre, more preferably less than 125 mg per cubic centimetre. This corresponds to the initial density of the rod of aerosol-generating substrate prior to insertion of the aerosol-generating article into an aerosol-generating device.

Preferably, the density of the rod of aerosol-generating substrate is at least 75 mg per cubic centimetre, more preferably at least 80 mg per cubic centimetre, more preferably at least 85 mg per cubic centimetre, more preferably at least 90 mg per cubic centimetre, more preferably at least 95 mg per cubic centimetre, more preferably at least 100 mg per cubic centimetre, more preferably at least 105 mg per cubic centimetre, more preferably at least 110 mg per cubic centimetre.

For example, the density of the rod of aerosol-generating substrate may be between 75 mg per cubic centimetre and 300 mg per cubic centimetre, or between 80 mg per cubic centimetre and 275 mg per cubic centimetre, between 85 mg per cubic centimetre and 250 mg per cubic centimetre, or between 90 mg per cubic centimetre and 225 mg per cubic centimetre, or between 95 mg per cubic centimetre and 200 mg per cubic centimetre, or between 100 mg per cubic centimetre and 175 mg per cubic centimetre, or between 105 mg per cubic centimetre and 150 mg per cubic centimetre, or between 110 mg per cubic centimetre and 125 mg per cubic centimetre.

The rod of aerosol-generating substrate is adapted to be compressible to a final density upon insertion of the rod into the heating chamber of an aerosol-generating device. The rod of aerosol-generating substrate is preferably adapted to be compressible to a final density that is at least 1.1 times the initial density, more preferably at least 1.25 times the initial density, more preferably at least 1.5 times the initial density, more preferably at least 1.75 times the initial density, more preferably twice the initial density. The rod of aerosol-generating substrate may b e compressible to a final density that is up to 4 times the initial density.

For example, the rod of aerosol-generating substrate may be adapted to be compressible to a final density that is between 1.1 times and 4 times the initial density, or between 1.25 times and 4 times the initial density, or between 1.5 times and 4 times the initial density, or between 1.75 and 4 times the initial density, or between 2 times and 4 times the initial density, or between 1.1 times and 3 times the initial density, or between 1.25 times and 3 times the initial density, or between 1.5 times and 3 times the initial density, or between 1.75 and 3 times the initial density, or between 2 times and 3 times the initial density.

Preferably, the rod of aerosol-generating substrate is adapted to be compressible to a final density of at least 150 mg per cubic centimetre, more preferably at least 175 mg per cubic centimetre, more preferably at least 200 mg per cubic centimetre, more preferably at least 225 mg per cubic centimetre, more preferably at least 250 mg per cubic centimetre, more preferably at least 275 mg per cubic centimetre, more preferably at least 300 mg per cubic centimetre.

Preferably, the rod of aerosol-generating substrate is adapted to be compressible to a final density of less than 500 mg per cubic centimetre, more preferably less than 475 mg per cubic centimetre, more preferably less than 450 mg per cubic centimetre, more preferably less than 425 mg per cubic centimetre, more preferably less than 400 mg per cubic centimetre, more preferably less than 375 mg per cubic centimetre, more preferably less than 350 mg per cubic centimetre.

For example, the rod of aerosol-generating substrate is adapted to be compressible to a final density of between 150 mg per cubic centimetre and 500 mg per cubic centimetre, or between 175 mg per cubic centimetre and 475 mg per cubic centimetre, between 200 mg per cubic centimetre and 450 mg per cubic centimetre, or between 225 mg per cubic centimetre and 425 mg per cubic centimetre, or between 250 mg per cubic centimetre and 400 mg per cubic centimetre, or between 275 mg per cubic centimetre and 375 mg per cubic centimetre, or between 300 mg per cubic centimetre and 350 mg per cubic centimetre.

Preferably, the rod of aerosol-generating substrate is provided with a density that is relatively similar to the density of the upstream element, such that it is easier to compress the upstream element and the rod of aerosol-generating substrate to the same extent when inserting the aerosol-generating article into an aerosol-generating device.

Preferably, the density of the rod of aerosol-generating substrate is at least 0.6 times the density of the upstream element, more preferably at least 0.7 times, more preferably at least 0.8 times the density of the upstream element.

Preferably, the density of the rod of aerosol-generating substrate is less than 1.4 times the density of the upstream element, more preferably less than 1.3 times, more preferably less than 1.3 times the density of the upstream element.

For example, the density of the rod of aerosol-generating substrate may be between 0.6 and 1.4 times the density of the upstream element, or between 0.7 and 1.3 times the density of the upstream element, or between 0.8 and 1.2 times the density of the upstream element. The density of the rod of aerosol-generating substrate may be substantially the same as the density of the upstream element.

Preferably, the rod of aerosol-generating substrate has a substantially circular transverse cross-section prior to insertion of the aerosol-generating article into an aerosol-generating device. After insertion of the aerosol-generating article into an aerosol-generating device, the rod of aerosol-generating substrate preferably has a substantially rectangular transverse cross-section. Alternatively, after insertion of the aerosol-generating article into the aerosol-generating device, the rod of aerosol-generating substrate may have a substantially oval transverse cross-section.

Preferably, the rod of aerosol-generating substrate has a length of at least 8 millimetres, more preferably a length of at least 9 millimetres, more preferably a length of at least 10 millimetres. Preferably, the length of the rod of aerosol-generating substrate is less than 16 millimetres, more preferably less than 15 millimetres, more preferably less than 14 millimetres. For example, the rod of aerosol-generating substrate may have a length of between 8 millimetres and 16 millimetres, or between 9 millimetres and 15 millimetres, or between 10 millimetres and 14 millimetres. In a particularly preferred embodiment, the rod of aerosol-generating substrate has a length of about 12 millimetres.

Preferably, the ratio between the length of the rod of aerosol-generating substrate and the overall length of the aerosol-generating article is at least 0.10, more preferably at least 0.15, more preferably at least 0.20, more preferably at least 0.25. Preferably, the ratio between the length of the rod of aerosol-generating substrate and the overall length of the aerosol-generating article is less than 0.50, more preferably less than 0.45, more preferably less than 0.40, more preferably less than 0.35. For example, the ratio between the length of the rod of aerosol-generating substrate and the overall length of the aerosol-generating article may be between 0.1 and 0.5, or between 0.15 and 0.45, or between 0.2 and 0.4, or between 0.25 and 0.35.

Prior to insertion of the aerosol-generating article into an aerosol-generating device, the rod of aerosol-generating substrate preferably has an external diameter that is approximately equal to the external diameter of the aerosol-generating article.

Preferably, prior to insertion of the aerosol-generating article into an aerosol-generating device, the rod of aerosol-generating substrate has an external diameter of at least 5 millimetres, more preferably at least 6 millimetres, more preferably at least 7 millimetres. Prior to insertion of the aerosol-generating article into an aerosol-generating device, the rod of aerosol-generating substrate preferably has an external diameter of less than 12 millimetres, more preferably less than 10 millimetres, more preferably less than 8 millimetres. For example, the external diameter may be between 5 millimetres and 12 millimetres, or between 6 millimetres and 10 millimetres, or between 7 millimetres and 8 millimetres. In a particularly preferred embodiment, the rod of aerosol-generating substrate has an external diameter of about 7.1 millimetres.

Preferably, the rod of aerosol-generating substrate has a substantially uniform cross-section along the length of the rod. Particularly preferably, the rod of aerosol-generating substrate has a substantially circular cross-section prior to insertion of the aerosol-generating article into the aerosol-generating device.

The aerosol-generating substrate may be a solid aerosol-generating substrate. Suitable types of materials for use in the aerosol-generating substrate are described below and include, for example, tobacco cut filler, homogenised tobacco material such as cast leaf, aerosol-generating films and gel compositions.

The aerosol-generating substrate preferably comprises an aerosol former. The aerosol former may be any suitable known compound or mixture of compounds that, in use, facilitates formation of a dense and stable aerosol. The aerosol former may be facilitating that the aerosol is substantially resistant to thermal degradation at temperatures typically applied during use of the aerosol-generating article. Suitable aerosol formers are for example: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Preferably, the aerosol former comprises one or more of glycerine and propylene glycol. The aerosol former may consist of glycerine or propylene glycol or of a combination of glycerine and propylene glycol.

In certain embodiments, the aerosol-generating substrate preferably comprises at least 5 percent by weight of aerosol former on a dry weight basis of the aerosol-generating substrate, more preferably at least 10 percent by weight on a dry weight basis, more preferably at least 15 percent by weight on a dry weight basis. In such embodiments, the aerosol-generating substrate preferably comprises no more than 30 percent by weight of aerosol former on a dry weight basis of the aerosol-generating substrate, more preferably no more than 25 percent by weight on a dry weight basis, more preferably no more than 20 percent by weight on a dry weight basis. For example, the aerosol former content of the aerosol-generating substrate may be between 5 percent and 30 percent by weight, or between 10 percent and 25 percent by weight, or between about 15 percent and about 20 percent by weight, on a dry weight basis. In such embodiments, the aerosol former content is therefore relatively low.

In other embodiments, the aerosol-generating substrate preferably comprises at least 40 percent by weight of aerosol former on a dry weight basis of the aerosol-generating substrate, more preferably at least 45 percent by weight on a dry weight basis, more preferably at least 50 percent by weight on a dry weight basis. In such embodiments, the aerosol-generating substrate preferably comprises no more than 80 percent by weight of aerosol former on a dry weight basis of the aerosol-generating substrate, more preferably no more than 75 percent by weight on a dry weight basis, more preferably no more than 70 percent by weight on a dry weight basis. For example, the aerosol former content of the aerosol-generating substrate may be between 40 percent and 80 percent by weight, or between 45 percent and 75 percent by weight, or between about 50 percent and about 70 percent by weight, on a dry weight basis. In such embodiments, the aerosol former content is therefore relatively high.

In some preferred embodiments, the aerosol-generating substrate comprises tobacco material. For example, the aerosol-generating substrate may comprise shredded tobacco material. For example, the shredded tobacco material may be in the form of cut filler, as described in more detail below. Alternatively, the shredded tobacco material may be in the form of a shredded sheet of homogenised tobacco material. Suitable homogenised tobacco materials for use in the present invention are described below.

Within the context of the present specification, the term “cut filler” is used to describe to a blend of shredded plant material, such as tobacco plant material, including, in particular, one or more of leaf lamina, processed stems and ribs, homogenised plant material.

The cut filler may also comprise other after-cut, filler tobacco or casing.

Preferably, the cut filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. Most preferably, the plant material is tobacco. However, the invention is equally applicable to other plant material that has the ability to release substances upon the application of heat that can subsequently form an aerosol.

The cut filler suitable to be used with the present invention generally may resemble cut filler used for conventional smoking articles. The cut width of the cut filler preferably may be between 0.3 millimetres and 2.0 millimetres, or between 0.5 millimetres and 1.2 millimetres, or between 0.6 millimetres and 0.9 millimetres.

Preferably, the strands have a length of between about 10 millimetres and about 40 millimetres before the strands are collated to form the rod of aerosol-generating substrate.

In preferred embodiments, the weight of the cut filler is between 25 milligrams and 150 milligrams, preferably between 30 milligrams and 125 milligrams, more preferably between 40 milligrams and 100 milligrams. This amount of cut filler typically allows for sufficient material for the formation of an aerosol during the early puffs.

Preferably, the cut filler is soaked with the aerosol former. Soaking the cut filler can be done by spraying or by other suitable application methods. The aerosol former may be applied to the blend during preparation of the cut filler. For example, the aerosol former may be applied to the blend in the direct conditioning casing cylinder (DCCC). Conventional machinery can be used for applying an aerosol former to the cut filler. Suitable aerosol formers are set out above.

Preferably, the aerosol former in the cut filler comprises one or more of glycerol and propylene glycol. The aerosol former may consist of glycerol or propylene glycol or of a combination of glycerol and propylene glycol.

In other preferred embodiments, the aerosol-generating substrate comprises homogenised plant material, preferably a homogenised tobacco material.

As used herein, the term “homogenised plant material” encompasses any plant material formed by the agglomeration of particles of plant. For example, sheets or webs of homogenised tobacco material for the aerosol-generating substrates of the present invention may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The homogenised plant material can be provided in any suitable form.

In some embodiments, the homogenised plant material may be in the form of one or more sheets. As used herein with reference to the invention, the term “sheet” describes a laminar element having a width and length substantially greater than the thickness thereof.

The homogenised plant material may be in the form of a plurality of pellets or granules.

The homogenised plant material may be in the form of a plurality of strands, strips or shreds. As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

The aerosol former content of the homogenised tobacco material is preferably within the ranges defined above for aerosol-generating substrate having a relatively low aerosol former content.

In other preferred embodiments, the aerosol-generating substrate is in the form of an aerosol-generating film comprising a cellulosic based film forming agent, nicotine and the aerosol former. The aerosol-generating film may further comprise a cellulose based strengthening agent. The aerosol-generating film may further comprise water, preferably 30 percent by weight of less of water.

As used herein, the term “film” is used to describe a solid laminar element having a thickness that is less than the width or length thereof. The film may be self-supporting. In other words, a film may have cohesion and mechanical properties such that the film, even if obtained by casting a film-forming formulation on a support surface, can be separated from the support surface. Alternatively, the film may be disposed on a support or sandwiched between other materials. This may enhance the mechanical stability of the film.

The aerosol former content of the aerosol-generating film is within the ranges defined above for aerosol-generating substrates having a relatively high aerosol former content.

In the context of the present invention the term “cellulose based film-forming agent” is used to describe a cellulosic polymer capable, by itself or in the presence of an auxiliary thickening agent, of forming a continuous film. Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof. In particularly preferred embodiments, the cellulose based film-forming agent is HPMC.

The aerosol-generating film may have a cellulose based film-forming agent content of between 10 percent and 40 percent by weight, or between 15 percent and 35 percent by weight, or between 20 percent and 30 percent by weight, on a dry weight basis.

Preferably, the aerosol-generating film further comprises a cellulose based strengthening agent. Preferably, the cellulose based strengthening agent is selected from the group consisting of cellulose fibres, microcrystalline cellulose (MCC), cellulose powder, and combinations thereof.

The aerosol-generating film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The aerosol-generating film may further comprise a carboxymethyl cellulose, preferably sodium carboxymethyl cellulose.

The aerosol-generating film may have a carboxymethyl cellulose content of between 1 percent and 15 percent by weight, or between 2 percent and 12 percent by weight, or between 4 percent and 10 percent by weight on a dry weight basis.

The aerosol-generating film preferably comprises nicotine. As used herein with reference to the invention, the term “nicotine” is used to describe nicotine, a nicotine base or a nicotine salt. In embodiments in which the aerosol-generating film comprises a nicotine base or a nicotine salt, the amounts of nicotine recited herein are the amount of free base nicotine or amount of protonated nicotine, respectively.

The aerosol-generating film may comprise natural nicotine or synthetic nicotine.

The aerosol-generating film may comprise one or more monoprotic nicotine salts. As used herein with reference to the invention, the term “monoprotic nicotine salt” is used to describe a nicotine salt of a monoprotic acid.

Preferably, the aerosol-generating film comprises between 0.5 percent and 10 percent by weight of nicotine, or between 1 percent and 8 percent by weight of nicotine, or between 2 percent and 6 percent by weight of nicotine, on a dry weight basis.

The aerosol-generating film may be a substantially tobacco-free aerosol-generating film.

In preferred embodiments, the aerosol-generating film comprises an acid. More preferably, the aerosol-generating film comprises one or more organic acids. Even more preferably, the aerosol-generating film comprises one or more carboxylic acids. In particularly preferred embodiments, the acid is lactic acid, benzoic acid, fumaric acid or levulinic acid.

Preferably, the aerosol-generating film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-generating film may have a thickness from about 0.1 millimetres to about 1 millimetre, more preferably from about 0.1 millimetres to about 0.75 millimetres, even more preferably from about 0.1 millimetres to about 0.5 millimetres. In particularly preferred embodiments, a layer of the film-forming composition is formed that has a thickness from about 50 micrometres to 400 micrometres, more preferably from about 100 micrometres to 200 micrometres.

The aerosol-generating film may optionally be provided within the aerosol-generating segment on a suitable carrier element.

In alternative embodiments of the invention, the aerosol-generating substrate may comprise a gel composition that includes nicotine, at least one gelling agent and the aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding. The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding. The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides. Biopolymers include, for example, gellan gums (native, low acyl gellan gum, high acyl gellan gums with low acyl gellan gum being preferred), xanthan gum, alginates (alginic acid), agar, guar gum, and the like.

The gel composition may further include a viscosifying agent. The term “viscosifying agent” refers to a compound that, when added homogeneously into a 25° C., 50 percent by weight water/50 percent by weight glycerol mixture, in an amount of 0.3 percent by weight., increases the viscosity without leading to the formation of a gel, the mixture staying or remaining fluid. The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. The divalent cation may be present in the gel composition in a range from about 0.1 to about 1 percent by weight, or about 0.5 percent by weight.

The gel composition may further include an acid. The acid may comprise a carboxylic acid, such as levulinic acid or lactic acid.

The gel composition preferably comprises some water. The gel composition is more stable when the composition comprises some water. Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the aerosol-generating substrate comprises a porous medium loaded with the gel composition. The term “porous” is used herein to refer to a material that provides a plurality of pores or openings that allow the passage of air through the material.

In certain embodiments of the invention, the aerosol-generating article further comprises one or more elongate susceptor elements within the rod of aerosol-generating substrate. For example, one or more elongate susceptor elements may be arranged substantially longitudinally within the rod of aerosol-generating substrate and in thermal contact with the aerosol-generating substrate.

As used herein with reference to the present invention, the term “susceptor element” refers to a material that can convert electromagnetic energy into heat. When located within a fluctuating electromagnetic field, eddy currents induced in the susceptor element cause heating of the susceptor element. As the susceptor element is located in thermal contact with the aerosol-generating substrate, the aerosol-generating substrate is heated by the susceptor element.

When used for describing the susceptor element, the term “elongate” means that the susceptor element has a length dimension that is greater than its width dimension or its thickness dimension, for example greater than twice its width dimension or its thickness dimension.

The susceptor element is arranged substantially longitudinally within the rod of aerosol-generating substrate. This means that the length dimension of the elongate susceptor element is arranged to be approximately parallel to the longitudinal direction of the rod, for example within plus or minus 10 degrees of parallel to the longitudinal direction of the rod. In preferred embodiments, the elongate susceptor element may be positioned in a radially central position within the rod or segment, and extends along the longitudinal axis of the rod or segment.

The susceptor element is preferably in the form of a pin, rod, strip or blade.

The susceptor element preferably has a width from 1 millimetre to 5 millimetres.

The susceptor element may generally have a thickness from 0.01 millimetres to 2 millimetres, for example from 0.5 millimetres to 2 millimetres. In some embodiments, the susceptor element preferably has a thickness from 10 micrometres to 500 micrometres, more preferably from 10 micrometres to 100 micrometres.

Preferably, the elongate susceptor element has a length which is the same or shorter than the length of the aerosol-generating segment in which it is incorporated. Preferably, the elongate susceptor element has a same length as the aerosol-generating segment in which it is incorporated.

The susceptor element may be formed from any material that can be inductively heated to a temperature sufficient to generate an aerosol from the aerosol-generating substrate. Preferred susceptor elements comprise a metal or carbon.

A preferred susceptor element may comprise or consist of a ferromagnetic material, for example a ferromagnetic alloy, ferritic iron, or a ferromagnetic steel or stainless steel. A suitable susceptor element may be, or comprise, aluminium.

Preferably, the rod of aerosol-generating substrate is circumscribed by a wrapper. The wrapper may be a paper wrapper or a non-paper wrapper.

Suitable paper wrappers for use in specific embodiments of the invention are known in the art and include, but are not limited to: cigarette papers; and filter plug wraps. Suitable non-paper wrappers for use in specific embodiments of the invention are known in the art and include, but are not limited to sheets of homogenised tobacco materials.

Aerosol-generating articles of aerosol-generating systems according to the present invention preferably further comprise a downstream section located downstream of the rod of aerosol-generating substrate. The downstream section is preferably located immediately downstream of the rod of aerosol-generating substrate. The downstream section of the aerosol-generating article preferably extends between the rod of aerosol-generating substrate and the downstream end of the aerosol-generating article. The downstream section may comprise one or more elements, each of which will be described in more detail within the present disclosure.

A length of the downstream section may be between 20 millimetres and 70 millimetres, or between 25 millimetres and 60 millimetres, or between 30 millimetres and 50 millimetres.

The downstream section preferably comprises a hollow tubular cooling element provided downstream of the rod of aerosol-generating substrate. The hollow tubular cooling element may advantageously provide an aerosol-cooling element for the aerosol-generating article.

The hollow tubular cooling element may be provided immediately downstream of the rod of aerosol-generating substrate. In other words, the hollow tubular cooling element may abut a downstream end of the rod of aerosol-generating substrate. The hollow tubular cooling element may define an upstream end of the downstream section of the aerosol-generating article. The downstream end of the aerosol-generating article may coincide with the downstream end of the downstream section. In some embodiments, the downstream section of the aerosol-generating article comprises a single hollow tubular element. In other words, the downstream section of the aerosol-generating article may comprise only one hollow tubular element. In other embodiments, the downstream section comprises two or more hollow tubular elements, as described below.

As used throughout the present disclosure, the term “hollow tubular element” denotes a generally elongate element defining a lumen or airflow passage along a longitudinal axis thereof.

In the context of the present invention, a hollow tubular cooling element provides an unrestricted flow channel. This means that the hollow tubular cooling element provides a negligible level of resistance to draw (RTD). The term “negligible level of RTD” is used to describe an RTD of less than 1 millimetres H₂O per 10 millimetres of length of the hollow tubular cooling element, preferably less than 0.4 millimetres H₂O per 10 millimetres of length of the hollow tubular cooling element, more preferably less than 0.1 millimetres H₂O per 10 millimetres of length of the hollow tubular cooling element.

The RTD of a hollow tubular cooling element is preferably less than or equal to 10 millimetres H₂O, or less than or equal to 5 millimetres H₂O, or less than or equal to 2.5 millimetres H₂O, or less than or equal to 2 millimetres H₂O, or less than or equal to 1 millimetre H₂O. The RTD of a hollow tubular cooling element may be at least 0 millimetres H₂O, or at least 0.25 millimetres H₂O or at least 0.5 millimetres H₂O or at least 1 millimetre H₂O.

The flow channel should therefore be free from any components that would obstruct the flow of air in a longitudinal direction. Preferably, the flow channel is substantially empty and particularly preferably the flow channel is empty.

The aerosol-generating article may comprise a ventilation zone at a location along the downstream section. In some embodiments, the aerosol-generating article may comprise a ventilation zone at a location along the hollow tubular cooling element. Such, or any, ventilation zone may extend through the peripheral wall of the hollow tubular cooling element. As such, fluid communication is established between the flow channel internally defined by the hollow tubular cooling element and the outer environment. The ventilation zone is further described within the present disclosure.

The length of the hollow tubular cooling element may be between 15 millimetres and 50 millimetres, or between 20 millimetres and 45 millimetres, or between 20 millimetres and 40 millimetres, or between 20 millimetres and 30 millimetres, or between 25 millimetres and 40 millimetres, or between 30 millimetres and 40 millimetres.

The wall thickness of the hollow tubular cooling element may between 100 micrometres and 2 millimetres, or between 150 micrometres and 1.5 millimetres, or between 200 micrometres and 1.25 millimetres.

The hollow tubular cooling element preferably has an external diameter that is approximately equal to the external diameter of the rod of aerosol-generating substrate and to the external diameter of the aerosol-generating article.

Preferably, the external diameter of the hollow tubular cooling element is between 5 millimetres and 12 millimetres, more preferably between 6 millimetres and 10 millimetres, more preferably between 7 millimetres and 8 millimetres. In some embodiments, the external diameter of the hollow tubular cooling element may be less than 7 millimetres, for example, between 5 millimetres and 7 millimetres, or between 6 millimetres and 7 millimetres.

Preferably, the hollow tubular cooling element may have a constant internal diameter along a length of the hollow tubular cooling element. However, the internal diameter of the hollow tubular cooling element may vary along the length of the hollow tubular cooling element.

The hollow tubular cooling element may have an internal diameter of at least 2 millimetres. For example, the hollow tubular cooling element may have an internal diameter of at least 3 millimetres, at least 4 millimetres, or at least 5 millimetres.

The hollow tubular cooling element may have an internal diameter of no more than 10 millimetres. For example, the hollow tubular cooling element may have an internal diameter of no more than 9 millimetres, no more than 8 millimetres, or no more than 7 millimetres.

The hollow tubular cooling element may have an internal diameter of between 2 millimetres and 10 millimetres, between 3 millimetres and 9 millimetres, between 4 millimetres and 8 millimetres, or between 5 millimetres and 7 millimetres.

The lumen or cavity of the hollow tubular cooling element may have any cross sectional shape. The lumen of the hollow tubular cooling element may have a circular cross sectional shape.

The hollow tubular cooling element may comprise a paper-based material. The hollow tubular cooling element may comprise at least one layer of paper. The paper may be very rigid paper. The paper may be crimped paper, such as crimped heat resistant paper or crimped parchment paper.

Preferably, the hollow tubular cooling element may comprise cardboard. The hollow tubular cooling element may be a cardboard tube. The hollow tubular cooling element may be formed from cardboard.

The hollow tubular cooling element may be a paper tube. The hollow tubular cooling element may be a tube formed from spirally wound paper. The hollow tubular cooling element may be formed from a plurality of layers of the paper. The paper may have a basis weight of at least 50 grams per square meter, at least 60 grams per square meter, at least 70 grams per square meter, or at least 90 grams per square meter.

The hollow tubular cooling element may comprise a polymeric material. For example, the hollow tubular cooling element may comprise a polymeric film. The polymeric film may comprise a cellulosic film. The hollow tubular cooling element may comprise low density polyethylene (LDPE) or polyhydroxyalkanoate (PHA) fibres. The hollow tube may comprise cellulose acetate tow.

Where the hollow tubular cooling element comprises cellulose acetate tow, the cellulose acetate tow may have a denier per filament of between 2 and 4 and a total denier of between 25,000 and 40,000.

In some embodiments, the aerosol-generating article of the aerosol-generating systems according to the present invention may comprise a ventilation zone at a location along the downstream section. In more detail, in those embodiments wherein the downstream section comprises a hollow tubular cooling element, the ventilation zone may be provided at a location along the hollow tubular cooling element.

The ventilation zone may typically comprise a plurality of perforations through the peripheral wall of the hollow tubular cooling element. Preferably, the ventilation zone comprises at least one circumferential row of perforations. In some embodiments, the ventilation zone may comprise two circumferential rows of perforations. For example, the perforations may be formed online during manufacturing of the aerosol-generating article. Preferably, each circumferential row of perforations comprises from 8 to 30 perforations.

An aerosol-generating article of the aerosol-generating systems of the present invention may have a ventilation level of at least 25 percent.

The term “ventilation level” is used throughout the present specification to denote a volume ratio between of the airflow admitted into the aerosol-generating article via the ventilation zone (ventilation airflow) and the sum of the aerosol airflow and the ventilation airflow. The greater the ventilation level, the higher the dilution of the aerosol flow delivered to the consumer. The aerosol-generating article preferably has a ventilation level of at least 25 percent, more preferably at least 30 percent, even more preferably at least 40 percent, even more preferably at least 50 percent.

An aerosol-generating article of the aerosol-generating systems of the present invention may have a ventilation level of up to 90 percent. Preferably, an aerosol-generating article in accordance with the present invention has a ventilation level of less than or equal to 80 percent, more preferably less than or equal to 70 percent, even more preferably less than or equal to 60 percent.

For example, an aerosol-generating article of the aerosol-generating systems of the present invention may have a ventilation level from 25 percent to 90 percent, preferably from 30 percent to 80 percent, more preferably from 40 percent to 70 percent, even more preferably from 50 percent to 60 percent.

The downstream section may further comprise a downstream filter segment. The downstream filter segment may extend to a downstream end of the downstream section. The downstream filter segment may be located at the downstream end of the aerosol-generating article. The downstream end of the downstream filter segment may define the downstream end of the aerosol-generating article.

The downstream filter segment may be located downstream of a hollow tubular cooling element, which is described above. The downstream filter segment may extend between the hollow tubular cooling element and the downstream end of the aerosol-generating article.

The downstream filter segment is preferably a solid plug, which may also be described as a ‘plain’ plug and is non-tubular. The filter segment therefore preferably has a substantially uniform transverse cross section.

The downstream filter segment is preferably formed of a fibrous filtration material. The fibrous filtration material may be for filtering the aerosol that is generated from the aerosol-generating substrate. Suitable fibrous filtration materials would be known to the skilled person. Particularly preferably, the at least one downstream filter segment comprises a cellulose acetate filter segment formed of cellulose acetate tow.

In certain preferred embodiments, the downstream section includes a single downstream filter segment. In alternative embodiments, the downstream section includes two or more downstream filter segments axially aligned in an abutting end to end relationship with each other.

Preferably, the downstream filter segment has a low particulate filtration efficiency.

Preferably, the downstream filter segment is circumscribed by a plug wrap. Preferably, the downstream filter segment is unventilated such that air does not enter the aerosol-generating article along the downstream filter segment.

The downstream filter segment is preferably connected to one or more of the adjacent upstream components of the aerosol-generating article by means of a tipping wrapper.

The downstream filter segment preferably has an external diameter that is between 5 millimetres and 12 millimetres, more preferably between 6 millimetres and 10 millimetres, more preferably between 7 millimetres and 8 millimetres. In some embodiments, the external diameter of the downstream filter segment may be less than 7 millimetres, for example, between 5 millimetres and 7 millimetres, or between 6 millimetres and 7 millimetres.

As mentioned above, the downstream filter segment may be formed of a fibrous filtration material. The downstream filter segment may be formed of a porous material. The downstream filter segment may be formed of a biodegradable material. The downstream filter segment may be formed of a cellulose material, such as cellulose acetate.

The downstream filter segment may be formed of a polylactic acid based material. The downstream filter segment may be formed of a bioplastic material, preferably a starch-based bioplastic material. The downstream filter segment may be made by injection moulding or by extrusion.

The length of the downstream filter segment may be between 5 millimetres and 25 millimetres, or between 10 millimetres and 25 millimetres, or between 5 millimetres and 20 millimetres, or between 10 millimetres and 20 millimetres.

The downstream section may further comprise one or more additional hollow tubular elements.

In certain embodiments, the downstream section may comprise a hollow tubular support element upstream of the hollow tubular cooling element described above. Preferably, the hollow tubular support element abuts the downstream end of the rod of aerosol-generating substrate. Preferably, the hollow tubular support element abuts the upstream end of the hollow tubular cooling element. Preferably, the hollow tubular support element and the hollow tubular cooling element are adjacent to each other and together provide a hollow tubular section within the downstream section.

Preferably, the hollow tubular support element is compressible.

The hollow tubular support element may be formed from any suitable material or combination of materials. For example, the support element may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, the support element is formed from cellulose acetate. Other suitable materials include polyhydroxyalkanoate (PHA) fibres. In a preferred embodiment, the hollow tubular support element comprises a hollow acetate tube.

The hollow tubular support element preferably has an external diameter that is approximately equal to the external diameter of the rod of aerosol-generating substrate and to the external diameter of the aerosol-generating article.

Preferably, the external diameter of the hollow tubular support element is between 5 millimetres and 12 millimetres, more preferably between 6 millimetres and 10 millimetres, more preferably between 7 millimetres and 8 millimetres. In some embodiments, the external diameter of the hollow tubular support element may be less than 7 millimetres, for example, between 5 millimetres and 7 millimetres, or between 6 millimetres and 7 millimetres.

The hollow tubular support element may have a wall thickness of at least 1 millimetre, preferably at least 1.5 millimetres, more preferably at least 2 millimetres.

The hollow tubular support element may have a length from 5 millimetres to 15 millimetres, preferably from 6 millimetres to 15 millimetres, more preferably from 7 millimetres to 15 millimetres. In other embodiments, the support element has a length from 5 millimetres to 12 millimetres, preferably from 6 millimetres to 12 millimetres, more preferably from 7 millimetres to 12 millimetres. In further embodiments, the support element has a length from 5 millimetres to 10 millimetres, preferably from 6 millimetres to 10 millimetres, more preferably from 7 millimetres to 10 millimetres.

Preferably, the hollow tubular support element is adapted such that it is compressible to a similar extent to the rod of aerosol-generating substrate. This enables at least the upstream part of the hollow tubular support element to be compressed in order to insert the aerosol-generating article into the heating device. The partial compression of the hollow tubular support element may be required in aerosol-generating systems in which the rod of aerosol-generating substrate is received entirely into the heating chamber and the upstream end of the hollow tubular segment may also be received into the heating chamber.

Preferably, the hollow tubular support element comprises a peripheral wall having a density of less than 200 mg per cubic centimetre, more preferably less than 175 mg per cubic centimetre, more preferably less than 150 mg per cubic centimetre, more preferably less than 140 mg per cubic centimetre, more preferably less than 130 mg per cubic centimetre.

Alternatively or in addition to the hollow tubular support element, the downstream section may further comprise a downstream hollow tubular element downstream of the hollow tubular cooling element.

The overall RTD of the aerosol-generating article after insertion of the aerosol-generating article into the aerosol-generating device is preferably at least 10 millimetres H₂O, more preferably at least 15 millimetres H₂O, more preferably at least 20 millimetres H₂O, more preferably at least 25 millimetres H₂O, more preferably at least 30 millimetres H₂O.

The overall RTD of the aerosol-generating article after insertion of the aerosol-generating article into the aerosol-generating device is preferably no more than 70 millimetres H₂O, more preferably no more than 60 millimetres H₂O, more preferably no more than 55 millimetres H₂O, more preferably no more than 50 millimetres H₂O, more preferably no more than 45 millimetres H₂O.

For example, the overall RTD of the aerosol-generating article after insertion of the aerosol-generating article into the aerosol-generating device may be between 10 millimetres H₂O and 70 millimetres H₂O, or between 15 millimetres H 20 and 60 millimetres H₂O, or between 20 millimetres H₂O and 55 millimetres H₂O, or between 25 millimetres H₂O and 45 millimetres H₂O, or between 30 millimetres H₂O and 45 millimetres H₂O.

The aerosol-generating article preferably has an overall length of from 40 millimetres to 80 millimetres, or from 40 millimetres to about 70 millimetres, or from 40 millimetres to about 60 millimetres, or from 45 millimetres to about 80 millimetres, or from about 45 millimetres to about 70 millimetres, or from 45 millimetres to 60 millimetres, or from 50 millimetres to 80 millimetres, or from 50 millimetres to about 70 millimetres or from about 50 millimetres to about 60 millimetres. In an exemplary embodiment, an overall length of the aerosol-generating article is about 45 millimetres.

The aerosol-generating article preferably has an external diameter of from 5 millimetres to 12 millimetres, or from 6 millimetres to 12 millimetres, or from 7 millimetres to 12 millimetres, or from 5 millimetres to 10 millimetres, or from 6 millimetres to 10 millimetres, or from 7 millimetres to 10 millimetres, or from 5 millimetres to 8 millimetres, or from 6 millimetres to 8 millimetres, or from 7 millimetres to 8 millimetres. In other embodiments, the aerosol-generating article has an external diameter of less than 7 millimetres.

The external diameter of the aerosol-generating article may be substantially constant over the whole length of the article, prior to insertion of the aerosol-generating article into the aerosol-generating device. As an alternative, different portions of the aerosol-generating article may have different external diameters. In particular, the rod of aerosol-generating substrate may have a different external diameter after insertion of the aerosol-generating article into the aerosol-generating device.

In particularly preferred embodiments, one or more of the components of the aerosol-generating article are individually circumscribed by their own wrapper.

Preferably, at least one of the components of the aerosol-generating article is wrapped in a hydrophobic wrapper.

The term “hydrophobic” refers to a surface exhibiting water repelling properties. One useful way to determine this is to measure the water contact angle. The “water contact angle” is the angle, conventionally measured through the liquid, where a liquid/vapour interface meets a solid surface. It quantifies the wettability of a solid surface by a liquid via the Young equation. Hydrophobicity or water contact angle may be determined by utilizing TAPPI T558 test method and the result is presented as an interfacial contact angle and reported in “degrees” and can range from near zero to near 180 degrees.

In preferred embodiments, the hydrophobic wrapper is one including a paper layer having a water contact angle of about 30 degrees or greater, and preferably about 35 degrees or greater, or about 40 degrees or greater, or about 45 degrees or greater.

By way of example, the paper layer may comprise PVOH (polyvinyl alcohol) or silicon. The PVOH may be applied to the paper layer as a surface coating, or the paper layer may comprise a surface treatment comprising PVOH or silicon.

According to the present invention, there is further provided an aerosol-generating system comprising an aerosol-generating article according to the invention, as described above, and an aerosol-generating device. The aerosol-generating device comprises: a body defining a heating chamber for removably receiving at least a portion of the rod of aerosol-generating substrate of the aerosol-generating article when the aerosol-generating article is inserted into the aerosol-generating device; and a heater assembly arranged along at least a portion of the heating chamber for heating the rod of aerosol-generating substrate when the aerosol-generating article is received within the aerosol-generating device. According to the invention, the heating chamber comprises a pair of opposed flat surfaces configured to receive the rod of aerosol-generating substrate between them and a heater element provided on or proximate to at least one of the pair of opposed flat surfaces. According to the invention, the cross-section of the heating chamber is configured such that upon insertion of the rod of aerosol-generating substrate into the heating chamber, the rod of aerosol-generating substrate and the upstream element are compressed, as described above.

As used herein with reference to the present invention, the term “heater assembly” refers to the component of the aerosol-generating device which is responsible for heating of the aerosol-generating substrate of the aerosol-generating article. As set out in more detail below, the heater assembly may heat the aerosol-generating substrates directly, this may be the case where the heater assembly comprises a resistive heater. The heater assembly may heat the aerosol-generating substrates indirectly, this may be the case where the heater assembly comprises an inductive coil.

The heating chamber of the aerosol-generating device may include an open downstream end and a closed upstream end. In use, the upstream end of the aerosol-generating device may be inserted into the open downstream end of the heating chamber. In use the upstream end of the aerosol-generating article may abut the upstream end of the heating chamber. Alternatively, the upstream end of the aerosol-generating article may abut another component within the heating chamber to prevent the aerosol-generating article moving any further upstream.

As used herein with reference to the present invention, the term “fully received” refers to the position when the aerosol-generating article is inserted into the heating chamber to the greatest extent it can. This may be when the upstream end of the aerosol-generating article abuts the upstream end of the heating chamber. Alternatively, this may be when the upstream end of the aerosol-generating article abuts another components within the heating chamber to prevent the aerosol-generating article moving any further upstream. When the aerosol-generating article is “fully received” in the heating chamber, a portion of the aerosol-generating article may protrude out of the open downstream end of the aerosol-generating article. This may be the case where, for example, the length of the aerosol-generating article is greater than that of the heating chamber, or when length of the aerosol-generating article is greater than the distance between the downstream end of the heating chamber and the component within the heating chamber to prevent the aerosol-generating article moving any further upstream, where present.

As described above, in order to insert the aerosol-generating article into the heating chamber, both the upstream element and the rod of aerosol-generating substrate must be compressed and deformed from their initial shape to a final shape that substantially matches the shape of the heating chamber. As described above, this compression will also result in an increase in the density of the upstream element and rod of aerosol-generating substrate. Preferably, the initial and final densities of the upstream element and rod of aerosol-generating substrate are within the ranges defined above in relation to the aerosol-generating article.

The length of the heating chamber may be between 15 millimetres and 80 millimetres. Preferably, the length of the heating chamber is between 20 millimetres and 70 millimetres. More preferably, the length of the heating chamber is between 25 millimetres and 60 millimetres. More preferably, the length of the heating chamber is between 25 millimetres and 50 millimetres.

The length of the heating chamber may be between 25 millimetres and 29 millimetres. Preferably, the length of the heating chamber is between 25 millimetres and 29 millimetres. More preferably, the length of the heating chamber is between 26 millimetres and 29 millimetres. Even more preferably, the length of the heating chamber is 27 millimetres or 28 millimetres.

The length of the heating chamber may be the same as or greater than the length of the rod of aerosol-generating substrate. Preferably, the length of the heating chamber is such that at least 75 percent of the rod of aerosol-generating substrate is inserted or received within the device heating chamber, when the aerosol-generating article is fully received within the heating chamber. More preferably, the length of the heating chamber is such that at least 80 percent of the rod of aerosol-generating substrate is inserted or received within the heating chamber, when the aerosol-generating article is fully received within the heating chamber. More preferably, the length of the heating chamber is such that at least 90 percent of the rod of aerosol-generating substrate is inserted or received within the heating chamber, when the aerosol-generating article is fully received within the heating chamber. This maximises the length of the rod of aerosol-generating substrate along which the aerosol-generating substrate can be heated during use, thereby optimising the generation of aerosol from the aerosol-generating substrate and reducing waste.

The length of the heating chamber may be such that the downstream section or a portion thereof is configured to protrude from the heating chamber, when the aerosol-generating article is fully received within the heating chamber. The length of the heating chamber may be such that a portion of the downstream section is configured to be received within the heating chamber, when the aerosol-generating article is fully received within the heating chamber.

As defined above, the heating chamber is configured such that upon insertion of the aerosol-generating article into the aerosol-generating device, there is a deformation or transformation of the rod of aerosol-generating substrate. The shape and size of the heating chamber are therefore configured relative to the shape and size of the rod of aerosol-generating substrate in order to bring about the desired deformation or transformation of the aerosol-generating substrate upon insertion of the rod of aerosol-generating substrate into the heating chamber. In particular, the transverse cross-section of the heating chamber is adapted such that the insertion of the rod of aerosol-generating substrate into the heating chamber brings about at least one of: an increase in the density of the aerosol-generating substrate, a decrease in the transverse cross-sectional area and an increase in the maximum diameter of the rod of aerosol-generating substrate.

Preferably, the transverse cross-sectional area of the heating chamber is smaller than the initial transverse cross-sectional area of the rod of aerosol-generating substrate.

As defined above, the heating chamber of the aerosol-generating device of aerosol-generating systems according to the present invention comprises a pair of opposed flat surfaces, configured to receive the rod of aerosol-generating substrate between them. The resultant heating assembly is preferably flat. The aerosol-generating device may also be flat. Preferably, the opposed flat surfaces are fixed relative to each other, within the heating chamber. The heater assembly preferably comprises a heater element provided on or proximate to at least one of the opposed flat surfaces. Preferably, the heater assembly comprises a heater element provided on or proximate to each of the opposed flat surfaces, so that the rod of aerosol-generating substrate is heated from both sides. In such an arrangement, the heater assembly comprises a pair of opposed heater elements, which heat the rod of aerosol-generating substrate from opposite sides. The opposed heater elements are preferably also flat, in order to provide a flat heating assembly.

As used herein, the term “flat” refers to a feature that extends substantially in a two dimensional plane. The definition of the surfaces of the heating chamber as “flat” means that the surfaces of the heating chamber extend substantially in a two dimensional plane. The surfaces therefore have a minimal curvature and preferably no curvature. The use of a heating chamber comprising opposed flat surfaces on which heater elements are provided increases the area of contact between the heater elements and the rod of aerosol-generating substrate, so that the aerosol-generating substrate can be heated more efficiently. The spacing of the opposed heater elements can also be adapted such that the distance between them is relatively small and heat can be efficiently transferred all of the way through the rod of aerosol-generating substrate.

The pair of opposed flat surfaces of the heating chamber are preferably substantially parallel to each other, such that the spacing between the opposed flat surfaces is substantially the same along the length of the heating chamber. The heating chamber therefore preferably has a substantially rectangular transverse cross-section.

The average spacing between the pair of opposed flat surfaces of the heating chamber is preferably less than 5 millimetres, more preferably less than 4.5 millimetres, more preferably less than 4 millimetres, more preferably less than 3.5 millimetres, more preferably less than 3 millimetres. The average spacing between the pair of opposed flat surfaces of the heating chamber is preferably at least 2 millimetres, more preferably at least 2.5 millimetres. The average spacing may therefore be between 2 millimetres and 5 millimetres, or between 2 millimetres and 4.5 millimetres, or between 2 millimetres and 4 millimetres, or between 2 millimetres and 3.5 millimetres, or between 2 millimetres and 3 millimetres, or between 2.5 millimetres and 5 millimetres, or between 2.5 millimetres and 4.5 millimetres, or between 2.5 millimetres and 4 millimetres, or between 2.5 millimetres and 3.5 millimetres, or between 2.5 millimetres and 3 millimetres.

The average spacing between the pair of opposed surfaces of the heating chamber is therefore typically considerably smaller than the diameter or maximum diameter of the rod of aerosol-generating substrate prior to insertion into the aerosol-generating device.

Preferably, the average spacing between the pair of opposed surfaces of the heating chamber is at least 1 millimetre less than the maximum diameter of the rod of aerosol-generating substrate prior to insertion of the aerosol-generating article into the aerosol-generating device. More preferably, the spacing between the pair of opposed surfaces of the heating chamber is at least 1.5 millimetre, or at least 2 millimetres, or at least 2.5 millimetres, or at least 3 millimetres less than the maximum diameter of the rod of aerosol-generating substrate prior to insertion of the aerosol-generating article into the aerosol-generating device. The spacing between the pair of opposed surfaces of the heating chamber may be up to 6 millimetres or up to 5 millimetres less than the maximum diameter of the rod of aerosol-generating substrate prior to insertion of the aerosol-generating article into the aerosol-generating device.

Preferably, the ratio of the initial outer diameter of the rod of aerosol-generating substrate to the spacing between the pair of opposed surfaces of the heating chamber is at least 1.5, more preferably at least 1.75, more preferably at least 2, more preferably at least 2.25. This ratio indicates the degree of compression of the rod of aerosol-generating substrate that is required in order to insert the rod of aerosol-generating substrate into the heating chamber.

Preferably, the heating chamber comprises a funnelled portion at the open downstream end, which has a cross-sectional area that decreases gradually from the downstream end towards the upstream end. This funnelled portion may advantageously facilitate the insertion of the rod of aerosol-generating substrate into the heating chamber and in particular, the gradual compression or flattening of the rod of aerosol-generating substrate from its initial shape to its final compressed shape.

In other preferred embodiments of the invention, the heating chamber may comprise a pair of movable walls, wherein at least one of the movable walls comprises a heater element on or proximate to its internal surface. The movable walls are adapted such that they may be moved relative to each other between an open position and a closed position. In the open position, the movable walls are apart from each other such that the rod of aerosol-generating substrate can be inserted between them. The movable walls may then be moved towards each other into a closed position, in which the walls are closed around the rod of aerosol-generating substrate. Once the movable walls have been closed together into their closed position, the rod of aerosol-generating substrate is then held between the walls, in contact with the internal surfaces thereof.

The movable walls are adapted such that upon closure of the movable walls, the desired compression and flattening of the rod of aerosol-generating substrate occurs. In such embodiments, the rod of aerosol-generating substrate is therefore compressed in a single step, after insertion of the aerosol-generating article into the aerosol-generating device. This may facilitate the insertion of the aerosol-generating article into the aerosol-generating device and the compression of the rod of aerosol-generating substrate.

Preferably, in the closed position, the movable walls have an average separation within the ranges set out above for the embodiments in which a pair of flat opposed surfaces is provided within the heating chamber. The aerosol-generating device may be provided with means for locking the movable walls in the closed position during use, such that the desired level of compression can be retained during heating.

Preferably, the movable walls are connected to each other at one end thereof, such that the movable walls form a jaw-like arrangement and can pivot relative to each other between an open position and a closed position. This optimises the degree of opening of the movable walls relative to each other, in order to facilitate the insertion of the aerosol-generating article into the aerosol-generating device.

The heater assembly may comprise a single heater element or a plurality of heater elements. Any suitable type of heater element may be used. The heater assembly may comprise at least one of a resistive heating element and an inductive heating assembly. The heater assembly may comprise an external heater or external heating element.

The heater assembly may externally heat the rod of aerosol-generating substrate when the aerosol-generating article is received within the aerosol-generating device. Such an external heater assembly may be provided on at least one side of the rod of aerosol-generating substrate when it is received within the heating chamber of the aerosol-generating device. Preferably, an external heater assembly is provided which heats the rod of aerosol-generating substrate on opposed sides, as described above.

The heater assembly may comprise at least one resistive heating element. The at least one resistive heating element may be any suitable type of resistive heating element. In some embodiments, the heater assembly comprises only one resistive heating element. In some embodiments, the heater assembly comprises a plurality of resistive heating elements. The heater may comprise at least one resistive heating element. Preferably, the heater assembly comprises a plurality of resistive heating elements. Preferably, the resistive heating elements are electrically connected in a parallel arrangement. Advantageously, providing a plurality of resistive heating elements electrically connected in a parallel arrangement may facilitate the delivery of a desired electrical power to the heater while reducing or minimising the voltage required to provide the desired electrical power. Advantageously, reducing or minimising the voltage required to operate the heater may facilitate reducing or minimising the physical size of the power supply.

In some embodiments, the at least one heating element comprises an electrically insulating substrate, wherein the at least one resistive heating element is provided on the electrically insulating substrate.

In some embodiments, the heater assembly comprises an inductive heating assembly. The inductive heating assembly may comprise an inductor coil. The aerosol-generating device may comprise a power supply configured to provide high frequency oscillating current to the inductor coil.

The heater assembly may comprise an inductively heated element. The inductively heated element may be a susceptor element. In these embodiments, the susceptor element is preferably located in contact with the aerosol-generating substrate. In some embodiments, a susceptor element is located in the aerosol-generating device. In these embodiments, the susceptor element may be located in the heating chamber. The aerosol-generating device may comprise only one susceptor element. The aerosol-generating device may comprise a plurality of susceptor elements. In some embodiments, the susceptor element is preferably arranged to heat the outer surface of the aerosol-generating substrate.

Where the heater assembly comprises both an induction coil and an inductively heated element, the heating zone is defined as the longitudinal space between the most upstream portion of the induction claim and the inductively heated element, and the most downstream portion of the induction claim and the inductively heated element.

The susceptor element may comprise any suitable material. Suitable materials for the elongate susceptor element include graphite, molybdenum, silicon carbide, stainless steels, niobium, aluminium, nickel, nickel containing compounds, titanium, and composites of metallic materials. Some susceptor elements comprise a metal or carbon. Advantageously the susceptor element may comprise or consist of a ferromagnetic material, for example, ferritic iron, a ferromagnetic alloy, such as ferromagnetic steel or stainless steel, ferromagnetic particles, and ferrite. A suitable susceptor element may be, or comprise, aluminium.

As described in more detail above, in some embodiments where the aerosol-generating device comprises an induction coil, the aerosol-generating article may comprise at least one susceptor element.

In some embodiments the aerosol-generating device may comprise at least one resistive heating element and at least one inductive heating assembly. In some embodiments the aerosol-generating device may comprise a combination of resistive heating elements and inductive heating assembly.

The aerosol-generating device may comprise an air-flow channel extending between a channel inlet and a channel outlet. The air-flow channel may be configured to establish a fluid communication between the interior of the device cavity and the exterior of the aerosol-generating device. The air-flow channel of the aerosol-generating device may be defined within the body of the aerosol-generating device to enable fluid communication between the interior of the heating chamber and the exterior of the aerosol-generating device. When an aerosol-generating article is received within the heating chamber, the air-flow channel may be configured to provide air flow into the article in order to deliver generated aerosol to a user drawing from the mouth end of the article.

The aerosol-generating device may comprise a power supply. The power supply may be a DC power supply. In some embodiments, the power supply is a battery.

Below, there is provided a non-exhaustive list of non-limiting examples. Any one or more of the features of these examples may be combined with any one or more features of another example, embodiment, or aspect described herein.

EX1. An aerosol-generating article comprising: a rod of aerosol-generating substrate; a downstream section extending from a downstream end of the rod of aerosol-generating substrate to the mouth end of the aerosol-generating article; and a compressible upstream element located upstream of the rod of aerosol-generating substrate.

EX2. An aerosol-generating article according to example EX1, wherein the rod of aerosol-generating substrate has a density of less than 300 mg per cubic centimetre.

EX3. An aerosol-generating article according to example EX1 or EX2, wherein the compressible upstream element has a density of less than 140 mg per cubic centimetre.

EX4. An aerosol-generating article according to any preceding example, wherein the upstream element is adapted to be compressible to a final density that is at least 1.5 times the initial density.

EX5. An aerosol-generating article according to any preceding example, wherein the upstream element is adapted to be compressible to a final density of at least 140 mg per cubic centimetre.

EX6. An aerosol-generating article according to any preceding example, wherein the upstream element is formed of fibrous filtration material.

EX7. An aerosol-generating article according to example EX6, wherein the fibrous filtration material has a denier per filament of less than 3.

EX8. An aerosol-generating article according to example EX6 or EX7, wherein the fibrous filtration material has a total denier of less than 30,000.

EX9. An aerosol-generating article according to any of examples EX6 to EX8, wherein the fibrous filtration material comprises a filter plasticiser and wherein the amount of filter plasticiser in the upstream element is less than 4 percent by weight of the upstream element.

EX10. An aerosol-generating article according to any preceding example, wherein the upstream element has a resistance to draw of less than 25 millimetres H₂O.

EX11. An aerosol-generating article according to any preceding example, wherein the upstream element has a length of between 3 millimetres and 7 millimetres.

EX12. An aerosol-generating article according to any preceding example, wherein the upstream element is circumscribed by a wrapper.

EX13. An aerosol-generating article according to example EX12, wherein the wrapper has a thickness of less than 40 microns.

EX14. An aerosol-generating article according to example EX12 or EX13, wherein the wrapper has a basis weight of less than 25 grams per square metre.

EX15. An aerosol-generating article according to any preceding example, wherein the density of the rod of aerosol-generating substrate is less than 125 mg per cubic centimetre.

EX16. An aerosol-generating article according to any preceding example, wherein the rod of aerosol-generating substrate is adapted to be compressible to a final density that is at least 1.1 times the initial density.

EX17. An aerosol-generating article according to any preceding example, wherein the rod of aerosol-generating substrate is adapted to be compressible to a final density of at least 300 mg per cubic centimetre.

EX18. An aerosol-generating article according to any preceding example, wherein the density of the rod of aerosol-generating substrate is between 0.8 and 1.2 times the density of the upstream element.

EX19. An aerosol-generating article according to example EX18, wherein the density of the rod of aerosol-generating substrate is substantially the same as the density of the upstream element.

EX20. AN aerosol-generating article according to any preceding example, wherein the rod of aerosol-generating substrate has a substantially circular transverse cross-section prior to insertion of the aerosol-generating article into an aerosol-generating device.

EX22. An aerosol-generating article according to any preceding example, wherein the rod of aerosol-generating substrate has a length of between 10 millimetres and 14 millimetres.

EX23. An aerosol-generating article according to any preceding example, wherein the aerosol-generating substrate comprises at least 15 percent by weight of aerosol former.

EX24. An aerosol-generating article according to any preceding example, wherein the aerosol-generating substrate comprises at least 40 percent by weight of aerosol former.

EX25. An aerosol-generating article according to any preceding claim, wherein the aerosol-generating substrate is substantially free from tobacco.

EX26. An aerosol-generating article according to any of examples EX1 to EX24, wherein the aerosol-generating substrate comprises homogenised tobacco material.

EX27. An aerosol-generating article according to any of examples EX1 to EX24, wherein the aerosol-generating substrate comprises cut filler.

EX28. An aerosol-generating article according to any of examples EX1 to EX25, wherein the aerosol-generating substrate comprises an aerosol-generating film comprising a cellulosic based film forming agent, nicotine and aerosol former.

EX29. An aerosol-generating article according to any of examples EX1 to EX25, wherein the aerosol-generating substrate comprises a gel composition comprises nicotine, at least one gelling agent and aerosol former.

EX30. An aerosol-generating article according to example EX29, wherein the gel composition is loaded onto a porous medium.

EX31. An aerosol-generating article according to any preceding example, further comprising one or more elongate susceptor elements within the rod of aerosol-generating substrate.

EX32. An aerosol-generating article according to any preceding example, further comprising a downstream section located downstream of the rod of aerosol-generating substrate.

EX33. An aerosol-generating article according to example EX32, wherein the downstream section comprises a compressible hollow tubular support element.

EX34. An aerosol-generating article according to example EX32 or EX33, wherein the hollow tubular support element comprises a peripheral wall having a density of less than 140 mg per cubic centimetre.

EX35. An aerosol-generating article according to any of examples EX32 to EX34, wherein the downstream section further comprises a hollow tubular cooling element.

EX36. An aerosol-generating article according to example EX35, further comprising a ventilation zone at a location along the hollow tubular cooling element.

EX37. An aerosol-generating article according to any of examples EX32 to EX36, wherein the downstream section further comprises a downstream filter segment.

EX38. An aerosol-generating article according to any preceding example, wherein the overall RTD of the aerosol-generating article Is at least 25 millimetres H₂O.

EX39. An aerosol-generating article according to any preceding example, wherein the rod of aerosol-generating substrate has a density of less than 200 mg per cubic centimetre.

EX40. An aerosol-generating article according to any preceding example, wherein upstream element has a density of less than 125 mg per cubic centimetre.

EX41. An aerosol-generating article according to any preceding example, further comprising an outer wrapper.

EX42. An aerosol-generating article according to example EX41, wherein the outer wrapper has a thickness of less than 65 microns.

EX43. An aerosol-generating article according to example EX41 or EX42, wherein the outer wrapper has a basis weight of less than 45 grams per square metre.

EX44. An aerosol-generating system comprising an aerosol-generating article according to any preceding example and an aerosol-generating device.

EX45. An aerosol-generating system according to example EX44, wherein the aerosol-generating device comprises: a body defining a heating chamber for removably receiving at least a portion of the rod of aerosol-generating substrate of the aerosol-generating article when the aerosol-generating article is inserted into the aerosol-generating device; and a heater assembly arranged along at least a portion of the heating chamber for heating the rod of aerosol-generating substrate when the aerosol-generating article is received within the aerosol-generating device.

EX46. An aerosol-generating system according to example EX45, wherein the heating chamber comprises a pair of opposed flat surfaces configured to receive the rod of aerosol-generating substrate between them and a heater element provided on or proximate to at least one of the pair of opposed flat surfaces.

EX47. An aerosol-generating system according to example EX46, wherein the pair of opposed flat surfaces of the heating chamber are substantially parallel to each other.

EX48. An aerosol-generating system according to example EX46 or EX47, wherein the average spacing between the pair of opposed flat surfaces of the heating chamber is less than 5 millimetres.

EX49. An aerosol-generating system according to any of examples EX46 to EX48 wherein the average spacing between the pair of opposed surfaces of the heating chamber is at least 1 millimetre less than the maximum diameter of the rod of aerosol-generating substrate prior to insertion of the aerosol-generating article into the aerosol-generating device.

EX50. An aerosol-generating article according to any of examples EX46 to EX49 wherein the ratio of the initial diameter of the rod of aerosol-generating substrate to the spacing between the pair of opposed surfaces of the heating chamber is at least 1.5.

EX51. An aerosol-generating system according to any of examples EX46 to EX50 wherein the cross-section of the heating chamber is configured such that upon insertion of the rod of aerosol-generating substrate into the heating chamber, the rod of aerosol-generating substrate and the upstream element are compressed.

EX52. An aerosol-generating system according to example EX51, wherein the transverse cross-sectional area of the heating chamber is smaller than the initial transverse cross-sectional area of the rod of aerosol-generating substrate.

EX53. An aerosol-generating system according to any of examples EX45 to EX52, wherein the heating chamber comprises a funnelled portion at the open downstream end, which has a cross-sectional area that decreases gradually from the downstream end towards the upstream end.

EX54. An aerosol-generating system according to any of examples EX45 to EX52, wherein the heating chamber comprises a pair of movable walls, wherein at least one of the movable walls comprises a heater element on or proximate to its internal surface and wherein the movable walls are adapted such that they may be moved relative to each other between an open position and a closed position.

EX55. An aerosol-generating system according to any of examples EX45 to EX54, wherein the heater assembly comprises an inductive heating assembly.

In the following, the invention will be further described with reference to the drawings of the accompanying Figures, in which:

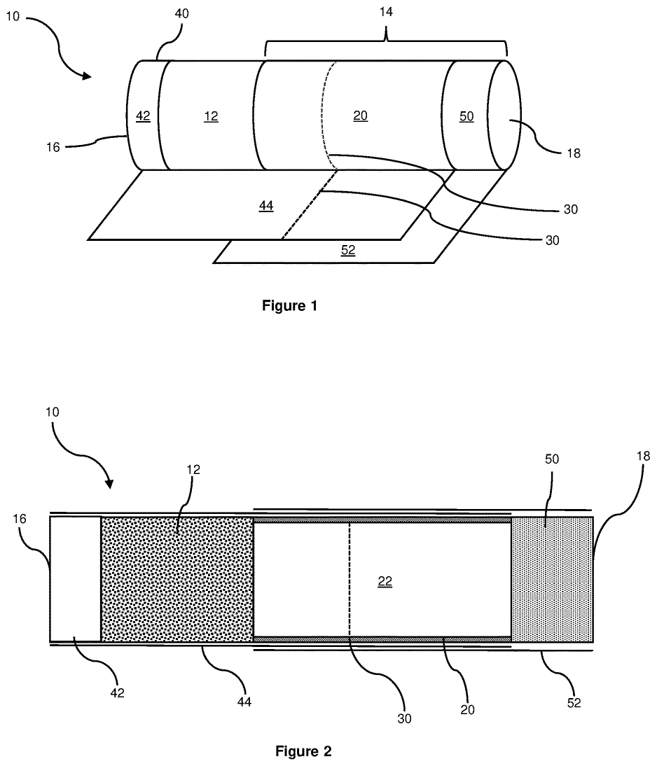

FIG. 1 shows a schematic side perspective view of a first aerosol-generating article for use in an aerosol-generating system according to the present invention;

FIG. 2 shows a schematic side sectional view of the first aerosol-generating article for use in an aerosol-generating system according to the present invention; and

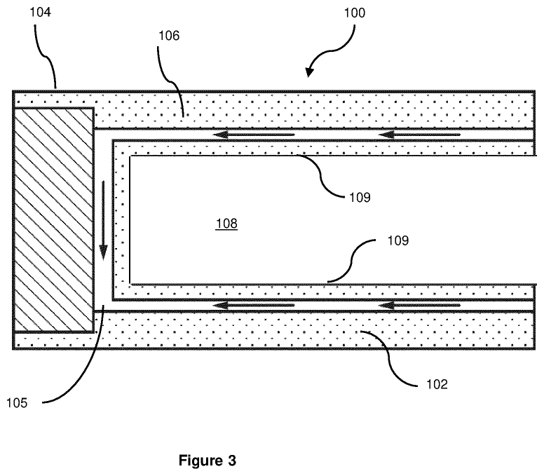

FIG. 3 shows a schematic side sectional view of the aerosol-generating device for use in an aerosol-generating article system according to the present invention.

The aerosol-generating article 10 shown in FIG. 1 comprises a rod of aerosol-generating substrate 12 and a downstream section 14 at a location downstream of the rod of aerosol-generating substrate 12. Thus, the aerosol-generating article 10 extends from an upstream or distal end 16—which substantially coincides with an upstream end of the rod 12—to a downstream or mouth end 18, which coincides with a downstream end of the downstream section 14. The downstream section 14 comprises a hollow tubular element 20 and a mouthpiece element 50.

The aerosol-generating article 10 has an overall length of about 45 millimetres and an outer diameter of about 7.1 millimetres.

The rod of aerosol-generating substrate 12 has a length of 12 millimetres and comprises a shredded tobacco material. The rod of aerosol-generating substrate 12 comprises about 70 milligrams of a shredded tobacco material comprising from 13 percent by weight to 16 percent by weight of glycerine. The bulk density of the rod of aerosol-generating substrate 12 is about 150 mg per cubic centimetre. The rod of aerosol-generating substrate 12 is cylindrical and has a circular transverse cross-section with an outer diameter of 7.1 millimetres. As the cross-section is circular, the maximum diameter of the rod of aerosol-generating substrate is therefore also 7.1 millimetres. The initial transverse cross-sectional area of the rod of aerosol-generating substrate is about 39.5 square millimetres.

The rod of aerosol-generating substrate 12 is individually wrapped by a plug wrap (not shown).

The hollow tubular element 20 is located immediately downstream of the rod of aerosol-generating substrate 12, the hollow tubular element 20 being in longitudinal alignment with the rod 12. The upstream end of the hollow tubular element 20 abuts the downstream end of the rod of aerosol-generating substrate 12.

The hollow tubular element 20 defines a hollow section of the aerosol-generating article 10. The hollow tubular element does not substantially contribute to the overall RTD of the aerosol-generating article. In more detail, an RTD of the hollow tubular element 20 is about 0 mm H₂O.

As shown in FIG. 2, the hollow tubular element 20 is provided in the form of a hollow cylindrical tube made of cardboard. The hollow tubular element 20 defines an internal cavity 22 that extends all the way from an upstream end of the hollow tubular element 20 to a downstream end of the hollow tubular element 20. The internal cavity 22 is substantially empty, and so substantially unrestricted airflow is enabled along the internal cavity 22. The hollow tubular element 20 does not substantially contribute to the overall RTD of the aerosol-generating article 10.

The hollow tubular element 20 has a length of about 21 millimetres, an external diameter of about 7.1 millimetres, and an internal diameter of about 6.7 millimetres. Thus, a thickness of a peripheral wall of the hollow tubular element 20 is about 0.25 millimetres.

The aerosol-generating article 10 comprises a ventilation zone 30 provided at a location along the hollow tubular element 20. In more detail, the ventilation zone 30 is provided at about 16 millimetres from the downstream end 18 of the article 10. The ventilation zone 30 is provided at about 12 mm downstream from the downstream end of the rod 12 of aerosol-generating substrate. The ventilation zone 30 is provided at about 9 millimetres upstream from the upstream end of the mouthpiece element 50. The ventilation zone 30 comprises a circumferential row of openings or perforations circumscribing the hollow tubular element 20. The perforations of the ventilation zone 30 extend through the wall of the hollow tubular element 20, in order to allow fluid ingress into the internal cavity 22 from the exterior of the article 10. A ventilation level of the aerosol-generating article 10 is about 16 percent.

The aerosol-generating article 10 further comprises an upstream section 40 at a location upstream of the rod of aerosol-generating substrate 12. As such, the aerosol-generating article 10 extends from a distal end 16 substantially coinciding with an upstream end of the upstream section 40 to a mouth end or downstream end 18 substantially coinciding with a downstream end of the downstream section 14.

The upstream section 40 comprises an upstream element 42 located immediately upstream of the rod 12 of aerosol-generating substrate, the upstream element 42 being in longitudinal alignment with the rod 12. The downstream end of the upstream element 42 abuts the upstream end of the rod 12 of aerosol-generating substrate. The upstream element 42 is provided in the form of a solid cylindrical plug of cellulose acetate tow. The bulk density of the upstream element is about 120 mg per cubic centimetre. The upstream element 42 has a length of about 5 millimetres. An external diameter of the upstream element 42 is about 7.1 millimetres.

The mouthpiece element 50 extends from the downstream end of the hollow tubular element 20 to the downstream or mouth end of the aerosol-generating article 10. The mouthpiece element 50 has a length of about 7 millimetres. An external diameter of the mouthpiece element 50 is about 7.1 millimetres. The mouthpiece element 50 comprises a low-density, cellulose acetate filter segment. The RTD of the mouthpiece element 50 is about 8 mm H₂O. The mouthpiece element 50 may be individually wrapped by a plug wrap (not shown).

As shown in FIGS. 1 & 2, the article 10 comprises an upstream wrapper 44 circumscribing the upstream element 42, the rod of aerosol-generating substrate 12 and the hollow tubular element 20. The ventilation zone 30 may also comprise a circumferential row of perforations provided on the upstream wrapper 44. The perforations of the upstream wrapper 44 overlap the perforations provided on the hollow tubular element 20. Accordingly, the upstream wrapper 44 overlies the perforations of the ventilation zone 30 provided on the hollow tubular element 20.

The article 10 also comprises a tipping wrapper 52 circumscribing the hollow tubular element 20 and the mouthpiece element 50. The tipping wrapper 52 overlies the portion of the upstream wrapper 44 that overlies the hollow tubular element 20. This way the tipping wrapper 52 effectively joins the mouthpiece element 50 to the rest of the components of the article 10. The width of the tipper wrapper 52 is about 26 mm. Additionally, the ventilation zone 30 may comprise a circumferential row of perforations provided on the tipping wrapper 52. The perforations of the tipping wrapper 52 overlap the perforations provided on the hollow tubular element 20 and the upstream wrapper 44. Accordingly, the tipping wrapper 52 overlies the perforations of the ventilation zone 30 provided on the hollow tubular element 20 and the upstream wrapper 44.

FIG. 3 illustrates an aerosol-generating device for use in conjunction with the aerosol-generating article 10 shown in FIGS. 1 and 2. The aerosol-generating device is shown prior to insertion of the aerosol-generating article.

The aerosol-generating device 100 shown in FIG. 3 comprises a housing (or body) 102, extending between a mouth end 104 and a distal end (not shown). The housing 102 comprises a peripheral wall 106. The peripheral wall 106 defines an elongate heating chamber 108 for receiving an aerosol-generating article 10. The heating chamber 108 is defined by a closed, distal end and an open, mouth end. The mouth end 104 of the heating chamber 108 is located at the mouth end of the aerosol-generating device 100. The aerosol-generating article 10 is configured to be received through the mouth end 104 of the heating chamber 108 and is configured to abut a closed end of the heating chamber 108.

The heating chamber 108 has a substantially rectangular transverse cross-section defining a pair of opposed flat walls 109 which are substantially parallel to each other and spaced apart from each by about 2 millimetres. During use, the rod of aerosol-generating substrate 12 of the aerosol-generating article 10 will be inserted between the opposed flat walls 109. Each of the opposed flat walls 109 is provided with a planar heating element (not shown) which is in the form of a resistive heating element. The heating chamber therefore provides a heater assembly comprising a pair of opposed flat heater elements, or heater plates. During use, when the rod of aerosol-generating substrate 12 is inserted between the opposed flat walls 109, aerosol-generating substrate will therefore be heated from the top and bottom by the opposed heater elements.

The spacing between the opposed flat walls 109 of the heating chamber 108 is around 5 millimetres less than the diameter of the rod of aerosol-generating substrate 12 prior to the insertion of the aerosol-generating article 10 into the aerosol-generating device 100. The rod of aerosol-generating substrate 12 is therefore significantly compressed as it is inserted into the heating chamber 108. This is described in more detail below.

A device air flow channel 105 is defined within the peripheral wall 106. The air-flow channel 105 extends between an inlet 107 located at the mouth end of the aerosol-generating device 100 and the closed end of the heating chamber. Air may enter the aerosol-generating substrate 12 via an aperture (not shown) provided at the closed end of the device cavity, ensuring fluid communication between the air flow channel 105 and the aerosol-generating substrate 12.

The aerosol-generating device 100 further comprises a power source (not shown) for supplying power to the heater elements. A controller (not shown) is also provided to control such supply of power to the heater elements. The heater elements are configured to controllably heat the aerosol-generating article 10 during use, when the aerosol-generating article 10 is received within the device 100. The heater is preferably arranged to externally heat the aerosol-generating substrate 12 for optimal aerosol generation. The ventilation zone 30 is arranged to be exposed when the aerosol-generating article 10 is received within the aerosol-generating device 100.

In order to insert the aerosol-generating article 10 into the aerosol-generating device 100, the upstream element 42 and the rod of aerosol-generating substrate 12 must be compressed and flattened such that the cross-sectional dimensions of the upstream element 42 and rod of aerosol-generating substrate 12 substantially match that of the heating chamber 108 of the aerosol-generating device. In particular, the upstream element and rod of aerosol-generating substrate, which both have an initial diameter of 7.1 millimetres, must be compressed such that they are both flattened in one dimension to a thickness that substantially matches the spacing of the opposed flat walls 109 of the heating chamber 108, which is about 2 millimetres.

In order to insert the upstream end of the rod of aerosol-generating substrate 12 into the heating chamber 108, the consumer may need to squeeze or pinch the upstream end in order to flatten it. Once the end of the aerosol-generating article 10 is in place in the heating chamber 108, the aerosol-generating article 10 can then be pushed in an upstream direction to insert the rod of aerosol-generating substrate as far as possible into the heating chamber 108. The remainder of the rod of aerosol-generating substrate 12 will compress and flatten as the aerosol-generating article 10 is pushed inwards.

Once the rod of aerosol-generating substrate 12 is fully received in the heating chamber 108, it has a rectangular transverse cross-section with a height of 2 millimetres and a width of approximately 9 millimetres. This width corresponds to the final maximum diameter of the rod of aerosol-generating substrate 12. The final maximum diameter is therefore about 1.25 times the initial maximum diameter. Following the compression of the rod of aerosol-generating substrate 12, it has an increased density of about 315 mg per cubic centimetre. The final density of the aerosol-generating substrate is therefore more than twice the initial density. The transverse cross-sectional area has decreased to about 18 square millimetres. The initial transverse cross-sectional area is therefore more than twice the final cross-sectional area.

The compression of the rod of aerosol-generating substrate 12 into a rectangular form increases the area of contact between the aerosol-generating substrate and the heater elements and also reduces the distance over which the heat needs to be transferred in order to effectively heat all of the aerosol-generating substrate within the rod. The aerosol-generating substrate can therefore be heated very efficiently, such that waste of tobacco material is minimised.

The upstream element 42 is also compressed to a similar cross-sectional shape and size as the rod of aerosol-generating substrate 12. Following compression of the upstream element 42, it has a final density of 150 mg per cubic centimetre. The final density is therefore approximately 1.25 times the initial density. The change in the shape and dimensions of the upstream element 42 as a result of its compression will be substantially the same as defined above in relation to the rod of aerosol-generating substrate.

1.-15. (canceled)

16. An aerosol-generating article for producing an inhalable aerosol upon heating, the aerosol-generating article extending from a mouth end to a distal end and comprising:
a rod of aerosol-generating substrate having a density of less than 300 mg per cubic centimetre;
a downstream section located downstream of the rod of aerosol-generating substrate, the downstream section extending from a downstream end of the rod of aerosol-generating substrate to the mouth end of the aerosol-generating article; and
a compressible upstream element located upstream of the rod of aerosol-generating substrate,
wherein the compressible upstream element is formed from a filter material and has a density of less than 140 mg per cubic centimetre.

17. The aerosol-generating article according to claim 16, wherein the compressible upstream element comprises a segment of a fibrous filtration material having a denier per filament (dpf) of less than 3.

18. The aerosol-generating article according to claim 17, wherein the compressible upstream element further comprises a segment of cellulose acetate tow.

19. The aerosol-generating article according to claim 17,
wherein the fibrous filtration material comprises a plasticiser, and
wherein an amount of plasticiser is less than 4 percent by weight of the compressible upstream element.

20. The aerosol-generating article according to claim 16, wherein the compressible upstream element comprises cardboard or paper.

21. The aerosol-generating article according to claim 16, wherein the compressible upstream element is a hollow tubular segment having a central longitudinal cavity extending therethrough.

22. The aerosol-generating article according to claim 16, wherein the compressible upstream element has a resistance to draw (RTD) of less than 25 mm H₂O.

23. The aerosol-generating article according to claim 16, wherein the compressible upstream element is circumscribed by a wrapper having a thickness of less than 35 microns.

24. The aerosol-generating article according to claim 16, wherein the compressible upstream element is circumscribed by a wrapper having a basis weight of less than 30 grams per square metre.

25. The aerosol-generating article according to claim 16, wherein a density of the aerosol-generating substrate is between 0.6 and 1.4 times a density of the compressible upstream element.

26. The aerosol-generating article according to claim 16,
wherein the downstream section comprises a compressible hollow tubular support element abutting the downstream end of the rod of aerosol-generating substrate, and
wherein the compressible hollow tubular support element comprises a peripheral wall having a density of less than 200 mg per cubic centimetre.

27. The aerosol-generating article according to claim 16, wherein the aerosol-generating substrate comprises a shredded tobacco material.

28. The aerosol-generating article according to claim 16, wherein the aerosol-generating substrate comprises an aerosol-generating film comprising nicotine and at least one aerosol former.

29. The aerosol-generating article according to claim 16, further comprising an elongate susceptor element extending longitudinally through the rod of aerosol-generating substrate.

30. An aerosol-generating system, comprising:
an aerosol-generating article according to claim 16; and
an aerosol-generating device comprising:
a body defining a heating chamber configured to removably receive at least a portion of the rod of aerosol-generating substrate of the aerosol-generating article when the aerosol-generating article is inserted into the aerosol-generating device, and
a heater assembly arranged along at least a portion of the heating chamber and being configured to heat the rod of aerosol-generating substrate when the aerosol-generating article is received within the aerosol-generating device,
wherein the heating chamber comprises a pair of opposed flat surfaces configured to receive the rod of aerosol-generating substrate therebetween,
wherein at least one of the opposed flat surfaces comprises a heater element, and
wherein a cross-section of the heating chamber of the aerosol-generating device is configured such that upon insertion of the rod of aerosol-generating substrate into the heating chamber, the rod of aerosol-generating substrate and the compressible upstream element are compressed.
